(19) United States
(12) Patent Application Publication
(10) Pub. No.: US 2015/0024370 A1
(43) Pub. Date: Jan. 22, 2015

(54) DRY-WIPE WHITEBOARD CAPABLE OF PASTING REPEATEDLY FOR BOTH SOLVENT-BASED PEN AND WATER-BASED PEN

(71) Applicant: Hasting G. Chen, New Taipei City (TW)

(72) Inventor: Chen Chia Chen, Taipei (TW)

(73) Assignee: Shurtech Brands, LLC, Avon, OH (US)

(21) Appl. No.: 14/333,996

(22) Filed: Jul. 17, 2014

(30) Foreign Application Priority Data
Jul. 17, 2013 (TW) 102213470

(51) Int. Cl. B43L 1/00

(52) U.S. Cl. CPC B43L 1/00
USPC 434/425

(57) ABSTRACT

A dry-wipe whiteboard capable of pasting repeatedly for use with both solvent-based pens and water-based pens comprises a whiteboard layer, a plastic layer, a permanent adhesive layer, a plastic carrier layer, and an elastic adhesive layer. The whiteboard is light weight and easily portable and can be used at any time and in any location. The whiteboard includes a whiteboard exterior layer that can be written on by solvent-based or water-based whiteboard pens without limits and is dry erasable. The whiteboard can be affixed to the wall, wood surface, iron surface, plastic surface, ceramic tile surface, glass surface, or any other selected surface through its elastic adhesive layer. The whiteboard can be removed according to the need of the user, without any damage to the contact surface. The whiteboard can be removed from the wall, glass surface or other contact surfaces without any damage or adhesive residue remaining thereafter to affect the appearance of the wall surface.

### RELATED APPLICATION

This application claims priority to Taiwan Patent Application No. 102213470, filed Jul. 17, 2013, the contents of which are fully incorporated by reference herein.

### TECHNOLOGY FIELD

This disclosure relates to a dry-wipe whiteboard capable of pasting repeatedly or removably adhering repeatedly and usable with both a solvent-based pen and a water-based pen. The dry-wipe whiteboard is dry erasable, light, easily portable, and is well suited for solvent-based pens or water-based pens. It can also be repeatedly pasted or removably adhered at any position for an unlimited number of mounts and removed to be pasted or adhered to other desired positions.

### BRIEF DESCRIPTION

The disclosure provides a dry-wipe whiteboard capable of pasting repeatedly for use with solvent-based pens and water-based pens. The whiteboard is light weight and easily portable, and can be used and mounted an unlimited number of times in a multitude of positions or locations. The whiteboard layer or surface, can be written on by solvent-based or water-based whiteboard pens without limits and is dry erasable.

The present disclosure further provides for a whiteboard capable of pasting repeatedly, which can be affixed to the wall, wood surface, iron surface, plastic surface, ceramic tile surface, glass surface or any other attachment positions by means of its elastic adhesive layer.

The disclosure further provides a whiteboard capable of pasting repeatedly, which can be removed according to the user's needs, without any damage to the contact surface, to be dismounted and placed or moved to other desired attachment positions.

The disclosure further provides a whiteboard capable of pasting repeatedly, which has the advantages of low cost and improved product competitiveness.

The disclosure further provides a whiteboard capable of pasting repeatedly, which can be removed from the wall, glass surface or other contact surfaces without any damage or adhesive residue to affect the appearance of said contact surface after removal.

A dry-wipe whiteboard capable of pasting repeatedly or removably adhering for use with both solvent-based pens and water-based pens comprises a whiteboard layer, a plastic layer, a permanent adhesive layer, a plastic carrier layer and an elastic adhesive layer. The whiteboard is light weight and easily portable and can be used on any contact surface and in any attachment position. With its whiteboard layer, the whiteboard can be written on by solvent-based or water-based whiteboard pens without limits and is dry erasable. It can be affixed to the wall, wood surface, iron surface, plastic surface, ceramic tile surface, or glass surface, in any of a variety of positions through its elastic adhesive layer. It can be removed according to the user's needs, without any damage to the contact surface. The whiteboard can be relocated, placed, or moved to other desired attachment positions. The disclosure has the advantages of low cost and improved product competitiveness. The whiteboard can be removed from the wall, glass surface or other contact surfaces without any damage or adhesive residue to affect the appearance of said contact surfaces after removal.

### BRIEF DESCRIPTION OF THE DRAWINGS

FIG. 1 is a perspective view of embodiment of the dry wipe whiteboard according to the present disclosure;

FIG. 2 is another perspective view of the whiteboard; and,

FIG. 3 is a cross-sectional view of the whiteboard.

### EMBODIMENT

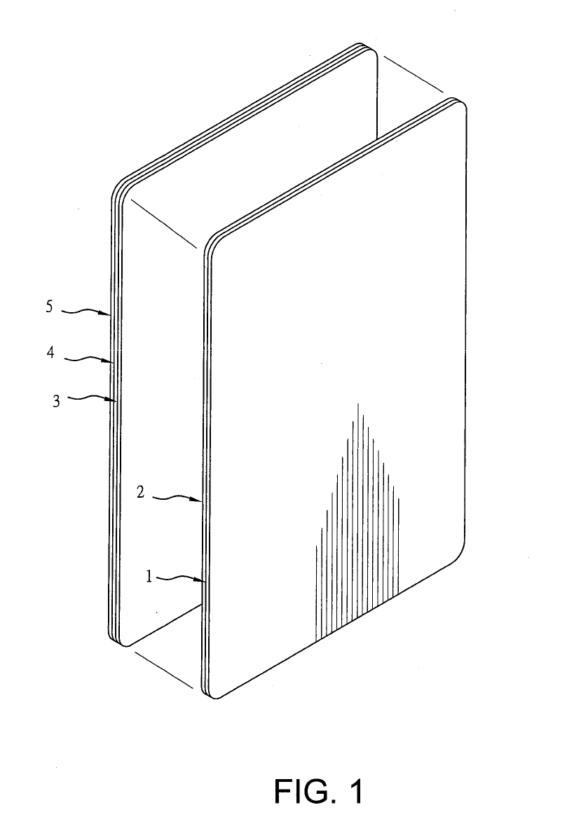

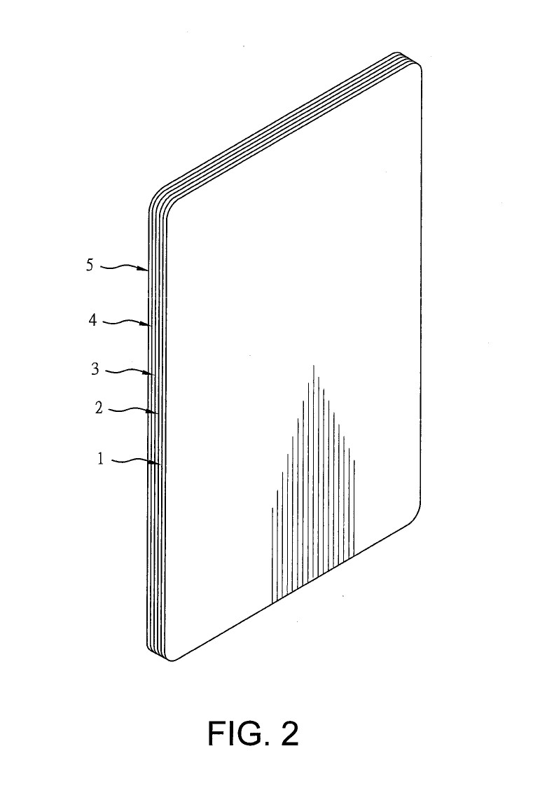

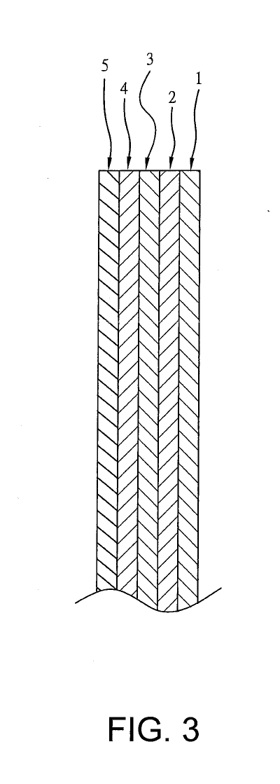

Refering to FIGS. 1-3, the invention is therein shown comprising a dry-wipe whiteboard W capable of pasting repeatedly for use with both solvent-based pens and water-based pens. The whiteboard W comprises a whiteboard layer 1, bonded to a front surface of a plastic layer 2. The whiteboard layer 1 can be a laminate sheet layer, aluminum foil layer, PVC sheet layer, PET sheet layer or UV hardened oily resin sheet layer. The plastic layer 2, which is adhered and affixed, on a side, to a permanent adhesive layer (acrylic adhesive layer) 3. The permanent adhesive layer 3, which is adhered and affixed, on a back side, to a plastic carrier layer 4. The plastic carrier layer 4, which is adhered and affixed, on its back, to an elastic adhesive layer 5. The plastic carrier layer 4 can comprise a PVC (Polyvinyl Chloride) plastic sheet, a PET (Polyethylene terephthalate) plastic sheet, a PP (Polypropylene) plastic sheet, an EVA (Ethylene vinyl acetate copolymer) plastic sheet, a PP (Polypropylene) synthetic paper sheet or a PE (Polyethylene) plastic sheet. The elastic adhesive layer 5, which is adhered and affixed to the back of the plastic carrier layer 4, can alternatively comprise a solution directly sprayed on the back of the plastic carrier layer 4 to form the elastic adhesive layer 5 after drying. The adhesive layer 5 can be affixed to the back of the plastic carrier layer 4.

With the aforementioned components, the whiteboard W can be used in a variety of mounting positions as well as, can be affixed to the wall, wood surface, iron surface, plastic surface, ceramic tile surface, glass surface, et al., or any other appropriate positions through its elastic adhesive layer 5. With its whiteboard layer 1, it can be written on by solvent-based or water-based whiteboard pens without limits and is erasable at any time without any influence to the contact surface. The whiteboard W can also be removed according to the user's needs, without any damage to the contact surface. The whiteboard W can be freely moved to other desired attachment positions, or can be re-applied, placed, or taken away to be used again at any time. In addition, several whiteboards W capable of pasting repeatedly can be combined into a mosaic board with a larger area. Due to its economical manufacturing costs and extensive applications, the whiteboard is very practical.

Furthermore, a total thickness of the aforementioned whiteboard can be from about 0.18 mm to 0.5 mm and is preferably from about 0.2 mm to about 0.3 mm.

In addition, the plastic layer 2 can comprise a PVC (Polyvinyl Chloride) plastic sheet, a PET (Polyethylene terephthalate) plastic sheet, a PP (Polypropylene) plastic sheet, an EVA (Ethylene vinyl acetate copolymer) plastic sheet, a PP (Polypropylene) synthetic paper sheet or a PE (Polyethylene) plastic sheet.

In summary, the present disclosure provides for the following improved effects: the inventive whiteboard is light weight and easily portable, and can be used at any time and in any of a variety of mounting surfaces and/or positions. With its whiteboard layer 1, it can be written on by solvent-based or water-based whiteboard pens without limits and is dry erasable.

The whiteboard can be affixed to the wall, wood surface, iron surface, plastic surface, ceramic tile surface, glass surface, et al., in any appropriate position or orientation through its elastic adhesive layer 5.

The whiteboard W can be removed according to the need of the user, without any damage to the contact surface. The whiteboard W can be remounted, placed, or moved to other desired attachment positions.

The inventive whiteboard W has the advantages of low cost and improved product competitiveness.

The whiteboard W can be removed from the wall, glass surface or other contact surfaces without any damage or adhesive residue remaining thereafter to affect the appearance of the contact surface.

The aforementioned contents are only some preferred embodiments of this disclosure, which do not define the entire scope. Any equivalent changes or modifications in accordance with the patent application ranges of this disclosure shall be covered by the disclosure.

The exemplary embodiments have been described with reference to the preferred embodiments. Obviously, modifications and alterations will occur to others upon reading and understanding the preceding detailed description. It is intended that the exemplary embodiments be construed as including all such modifications and alterations insofar as they come within the scope of the appended claims or the equivalents thereof.

1. A dry-wipe whiteboard capable of pasting repeatedly for use with both solvent-based and water-based pens comprises:
a whiteboard layer, bonded to a front surface of a plastic layer;
wherein the whiteboard layer comprises one or more of a laminate sheet layer, aluminum foil layer, a PVC sheet layer, a PET sheet layer, or a UV hardened oily resin sheet layer;
the plastic layer is adhered, on a back side, to a permanent adhesive layer;
the permanent adhesive layer is adhered, on a back side, to a plastic carrier layer;
the plastic carrier layer is adhered, on a back side, to an elastic adhesive layer;
the plastic carrier layer comprises one or more of a PVC (Polyvinyl Chloride) plastic sheet, a PET (Polyethylene terephthalate) plastic sheet, a PP (Polypropylene) plastic sheet, an EVA (Ethylene vinyl acetate copolymer) plastic sheet, a PP (Polypropylene) synthetic paper sheet, or a PE (Polyethylene) plastic sheet; and,
the elastic adhesive layer is adhered, to the back side of the plastic carrier layer, or elastic adhesive solution can be directly sprayed on the back of the plastic carrier layer to form the elastic adhesive layer after drying, which is fixed to the back of the plastic carrier layer.

2. The dry-wipe whiteboard according to claim 1, wherein a total thickness of the combined whiteboard layer, plastic layer, permanent adhesive layer, plastic carrier layer, and elastic adhesive layer is from about 0.18 mm to about 0.5 mm.

3. The dry-wipe white board according to claim 1, wherein the plastic sheet comprises one or more of a PVC (Polyvinyl Chloride) plastic sheet, a PET (Polyethylene terephthalate) plastic sheet, a PP (Polypropylene) plastic sheet, an EVA (Ethylene vinyl acetate copolymer) plastic sheet, a PP (Polypropylene) synthetic paper sheet or a PE (Polyethylene) plastic sheet.
